(19) United States
(12) Patent Application Publication
(10) Pub. No.: US 2022/0148063 A1
(43) Pub. Date: May 12, 2022

(54) SYSTEM AND METHOD FOR ONLINE SHOPPING BASED ON FACIAL EMOTIONAL STATE ANALYSIS

(71) Applicant: University of Science and Technology Beijing, Beijing (CN)

(72) Inventors: Lun XIE, Beijing (CN); Hang PAN, Beijing (CN)

(73) Assignee: University of Science and Technology Beijing, Beijing (CN)

(21) Appl. No.: 17/120,300

(22) Filed: Dec. 14, 2020

(30) Foreign Application Priority Data
Nov. 12, 2020 (CN) 202011262630.8

(51) Int. Cl. G06Q 30/06; G06T 5/00; G06T 7/10; G06K 9/00; G06K 9/32; G06K 9/62; G06T 9/00; G06N 20/10

(52) U.S. Cl. CPC G06Q 30/0631; G06T 5/002; G06T 7/10; G06K 9/00281; G06K 9/00302; G06T 2207/10016; G06K 9/6217; G06K 9/6288; G06T 9/002; G06N 20/10; G06T 2207/20084; G06K 9/3233

(57) ABSTRACT

An online shopping system based on facial emotional state analysis and a method thereof is provided. The system includes: an online shopping module configured for providing an online shopping interactive interface for a user and collecting facial image data and interactive behavior data of the user in an online shopping process; a facial expression recognition module configured for recognizing an emotional state of the user according to the collected facial image data in the online shopping process of the user; a shopping intention analysis module configured for deciding a shopping intention of the user according to the recognized emotional state and the interactive behavior data of the user; and a shopping recommendation adjustment module configured for dynamically adjusting a commodity recommendation strategy for the user according to the decided shopping intention of the user.

### CROSS-REFERENCE TO RELATED APPLICATIONS

This application is based upon and claims priority to Chinese Patent Application No. 202011262630.8, filed on Nov. 12, 2020, the entire contents of which are incorporated herein by reference.

### TECHNICAL FIELD

The present invention relates to the technical field of intelligent services, in particular to an online shopping system based on facial emotional state analysis and a method thereof.

### BACKGROUND

In recent years, technologies such as artificial intelligence and big data have developed rapidly. The combination of virtual economy and real economy driven by Internet and big data has brought revolutionary changes to people's work and lifestyle. Online shopping breaks the traditional shopping mode, and the data-driven recommendation algorithm introduces personalized factors such as commodity attributes and users' browsing transaction records into online shopping, analyzes users' shopping intentions through the recommendation algorithm, and gives the corresponding shopping recommendation lists, thus improving shopping efficiency of the users.

The traditional shopping process can be regarded as a communication process between merchants and customers, and merchants can give corresponding product recommendations by observing the facial emotional changes of customers. However, online shopping is a process of human-computer interaction. Shopping systems often don't analyze the changes in users' facial emotions, and the changes of users' emotions in the process of interaction will have a certain impact on shopping choices and shopping efficiency. However, the influence of users' emotional changes in the shopping environment is seldom taken into consideration for shopping recommendations, and corresponding recommendations cannot be provided according to users' emotions.

### SUMMARY

The object of the present invention is to provide an online shopping system and method based on facial emotional state analysis. Aiming at the lack of facial emotional analysis in online shopping at present, a facial emotion recognition method based on the combination of macro-expressions and micro-expressions analyzes the change of a user's emotional state in a shopping environment through the facial image, and analyzes the shopping intention of the user according to different emotional states and human-computer interaction contents, thereby improving the shopping experience of the user.

To solve the above technical problems, an embodiment of the present invention provides the following solution:

An online shopping system based on facial emotional state analysis, comprising:

an online shopping module configured to provide an online shopping interactive interface for a user and collect facial image data and interactive behavior data of the user in an online shopping process;

a facial expression recognition module configured to recognize an emotional state of the user according to the collected facial image data in the online shopping process of the user;

a shopping intention analysis module configured to decide a shopping intention of the user according to the recognized emotional state and the interactive behavior data of the user; and

a shopping recommendation adjustment module configured to dynamically adjust a commodity recommendation strategy for the user according to the decided shopping intention of the user.

Preferably, the online shopping module comprises:

a login sub-module configured to allow the user to input a user name and a password to register and log in to the system, and input account information and basic information of the user into a user database for storage;

a display sub-module comprising a three-level structure, namely a homepage, a commodity display page and a commodity detail page, wherein the homepage is a commodity category page; the display sub-module is configured for displaying commodity categories on the homepage for users to select interesting commodity categories to enter the commodity display page, and then for users to select interesting commodities from different commodities displayed on the commodity display page to enter the commodity detail page for browsing within a predetermined time; and

an acquisition sub-module configured to acquire the facial image data and interactive behavior data of the user in the online shopping process.

Preferably, the facial expression recognition module comprises:

a facial macro-expression feature extraction sub-module configured to extract facial macro-expression features according to the collected facial image data;

a facial micro-expression feature extraction sub-module configured to extract facial micro-expression features according to the collected facial image data;

a facial expression locating sub-module configured to locate different types of facial expressions according to the extracted facial macro-expression features and facial micro-expression features;

a facial emotional state recognition sub-module configured to hierarchically fuse different types of facial expression features in an orderly manner, and use a support vector machine to construct a classifier for facial emotional state recognition to classify a current emotional state of the user.

Preferably, the facial macro-expression feature extraction sub-module is specifically configured to:

adopt a public macro-expression dataset for training to obtain a macro-expression image coding model, wherein, the macro-expression image coding model is a bilinear convolutional neural network model;

implement noise reduction, segmentation and normalization pretreatment on the collected facial image data; and

input the pretreated data into the macro-expression image coding model, and extract the facial macro-expression features of the user.

Preferably, the facial micro-expression feature extraction sub-module is specifically configured to:

adopt a public micro-expression dataset for training to obtain a micro-expression image coding model, wherein the micro-expression image coding model is a two-stream difference network model;

implement noise reduction, segmentation and normalization pretreatment on the collected facial image data; and

input the pretreated data into the micro-expression image coding model, and extract the facial micro-expression features of the user.

Preferably, the facial expression locating sub-module is specifically configured to:

extract fine-grained change characteristics of local regions of interest in a face by the bilinear convolutional neural network model, and locate durations of different types of expressions in the process of data acquisition; based on the influence of deep local region extraction features on the classification of facial macro-expressions, micro-expressions, and natural expressions, select efficient local facial features for fusion with overall features to improve classification accuracy, and label each frame of images in a video sequence with emotional features, so as to locate different types of facial expressions in the video sequence.

Preferably, the facial emotion state recognition sub-module is specifically configured to: implement hierarchical fusion in an orderly manner according to different types of facial expression features, extract features that can best represent emotional categories from the facial macro-expression features, facial micro-expression features and fusion features according to a support vector machine classifier, and construct an optimal classification model to recognize a current emotional state of the user.

Preferably, the shopping intention analysis module is specifically configured to:

decide that the user is not interested in shopping content at this time when the emotional state of the user is recognized as a negative state or a negative micro-expression state is hidden with a positive facial expression, the browsing time of the user is short and interaction frequency is high; and

decide that the user is interested in shopping content at this time when the emotional state of the user is identified as a positive state or a positive micro-expression state is hidden by a negative facial expression, the browsing time of the user is long and interaction frequency is low.

Preferably, the shopping recommendation adjustment module is specifically configured to:

recommend similar products to the user when the emotional state of the user is positive, the interaction frequency with the shopping system is low and the browsing time is long; and

adjust the commodity recommendation strategy for the user when the emotional state of the user is negative, the interaction frequency with the shopping system is high and the browsing time is short.

An online shopping method based on facial emotional state analysis, comprising the following steps of:

providing an online shopping interactive interface for a user and collecting facial image data and interactive behavior data of the user in an online shopping process;

recognizing an emotional state of the user according to the collected facial image data in the online shopping process of the user;

deciding a shopping intention of the user according to the recognized emotional state and the interactive behavior data of the user; and

dynamically adjusting a commodity recommendation strategy for the user according to the decided shopping intention of the user.

The technical solution provided by the embodiment of the invention has at least the following beneficial effects:

In the embodiment of the invention, the emotional state of the user in the shopping environment is analyzed by collecting the facial image data of the user in the shopping process, and the shopping intention of the user is predicted according to the analysis of the emotional state of the user and the interaction behavior between the user and the shopping system, and the corresponding shopping recommendation is provided, thereby improving the shopping experience of the user.

### BRIEF DESCRIPTION OF DRAWINGS

In order to explain the technical solution in the embodiments of the present invention more clearly, the drawings used in the description of the embodiments will be briefly introduced below. Obviously, the drawings in the following description are only some embodiments of the present invention, and other drawings can be obtained according to these drawings without paying creative work.

FIG. 1 is a schematic structural diagram of an online shopping system based on facial emotional state analysis provided by an embodiment of the present invention;

FIG. 2 is a schematic diagram of the workflow of an embodiment of the present invention;

FIG. 3 is a schematic diagram of a specific framework of an embodiment of the present invention;

FIG. 4 is a schematic flow chart of the facial macro-expression and micro-expression location algorithm according to an embodiment of the present invention;

FIG. 5 is a schematic diagram of a facial emotion recognition model based on multi-feature fusion according to an embodiment of the present invention;

FIG. 6 is a schematic diagram of a shopping intention comprehension model according to an embodiment of the present invention;

FIG. 7 is a schematic flow chart of shopping recommendation adjustment based on an emotional state according to an embodiment of the present invention; and

FIG. 8 is a flow chart of an online shopping method based on facial emotional state analysis provided by an embodiment of the present invention.

### DETAILED DESCRIPTION OF THE EMBODIMENTS

In order to make the object, technical solution and advantages of the present invention clearer, the embodiments of the present invention will be further described in detail with reference to the accompanying drawings.

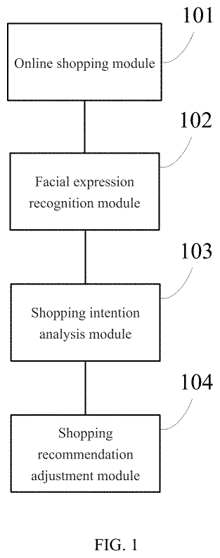

An embodiment of the present invention first provides an online shopping system based on facial emotional state analysis, as shown in FIG. 1, the system includes:

an online shopping module 101 configured to provide an online shopping interactive interface for a user and collect facial image data and interactive behavior data of the user in an online shopping process;

a facial expression recognition module 102 configured to recognize an emotional state of the user according to the collected facial image data in the online shopping process of the user;

a shopping intention analysis module 103 configured to decide a shopping intention of the user according to the recognized emotional state and the interactive behavior data of the user; and

a shopping recommendation adjustment module 104 configured to dynamically adjust a commodity recommendation strategy for the user according to the decided shopping intention of the user.

The online shopping system provided by the embodiment of the invention analyzes the emotional state of the user in the shopping environment by collecting the facial image data of the user in the shopping process, predicts the shopping intention of the user according to the analysis of the emotional state of the user and the interaction behavior between the user and the shopping system, and gives corresponding shopping recommendations, thereby improving the shopping experience of the user.

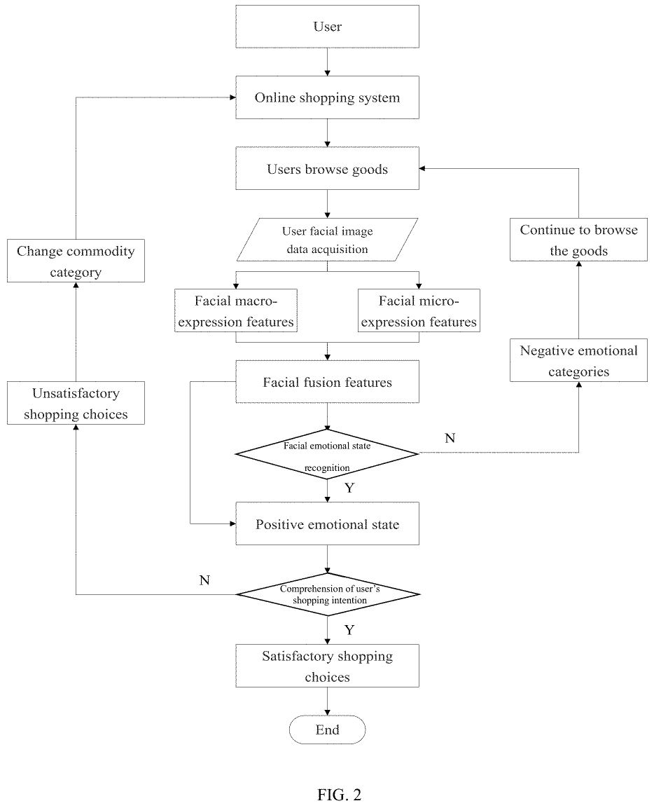

FIG. 2 is a schematic diagram of the workflow of an embodiment of the present invention. Firstly, the online shopping system collects facial image data and human-computer interaction behavior data during the shopping process, and then the user enters the homepage of the system to browse and select interesting commodity categories, and then selects the most interesting items to enter the commodity display page within a specific time. In this process, the system analyzes the collected facial image data in real time through the facial expression recognition module, and continuously monitors the shopping process of users. When the system finds that the user's emotional state continually changes into a negative emotional category, the recommended commodity content is adjusted to attract the user's attention. When the user's emotional state is positive, the user's shopping intention is predicted according to the user's interactive behavior data, and similar commodity content is continuously recommended. When the user is satisfied with the recommended shopping choice, the current shopping stage is ended;

otherwise, the recommended content of goods is adjusted until the appropriate goods are selected, and the system operation ends.

Furthermore, the online shopping module 101 includes:

a login sub-module configured to allow the user to input a user name and a password to register and log in to the system, and input account information and basic information of the user into a user database for storage; wherein, after logging in successfully, the user enters the personal space and can see the basic personal information of the user;

a display sub-module comprising a three-level structure, namely a homepage (i.e., a commodity category page), a commodity display page and a commodity detail page, wherein the display sub-module is configured for displaying commodity categories (for example: canvas bag, mobile phone case, umbrella, keyboard, mouse and so on) on the homepage for users to select interesting commodity categories to enter the commodity display page (display different products of the product category selected by the user, such as different types of canvas bags and different types of mobile phone cases, etc.), and then for users to select interesting commodities from different commodities displayed on the commodity display page to enter the commodity detail page for browsing within a predetermined time so that so that the user can make purchase choices from different commodities; and

an acquisition sub-module configured to acquire the facial image data and interactive behavior data of the user in the online shopping process.

Furthermore, the facial expression recognition module 102 includes:

a facial macro-expression feature extraction sub-module configured to extract facial macro-expression features according to the collected facial image data;

a facial micro-expression feature extraction sub-module configured to extract facial micro-expression features according to the collected facial image data;

a facial expression locating sub-module configured to locate different types of facial expressions according to the extracted facial macro-expression features and facial micro-expression features;

a facial emotional state recognition sub-module configured to hierarchically fuse different types of facial expression features in an orderly manner, and use a support vector machine to construct a classifier for facial emotional state recognition to classify a current emotional state of the user.

Furthermore, the facial macro-expression feature extraction sub-module is specifically configured to:

adopt a public macro-expression data set for training to obtain a macro-expression image coding model, wherein, the macro-expression image coding model is a bilinear convolutional neural network model;

implement noise reduction, segmentation and normalization pretreatment on the collected facial image data; and

input the pretreated data into the macro-expression image coding model, and extract the facial macro-expression features of the user.

Furthermore, the facial micro-expression feature extraction sub-module is specifically configured to:

adopt a public micro-expression data set for training to obtain a micro-expression image coding model, wherein the micro-expression image coding model is a two-stream difference network model;

implement noise reduction, segmentation and normalization pretreatment on the collected facial image data; and

input the pretreated data into the micro-expression image coding model, and extract the facial micro-expression features of the user.

A micro-expression is a kind of short-lived and imperceptible facial expression that the user cannot help showing in shopping scenes. The feature extraction model is also trained by a public micro-expression data set. The micro-expressions differ from macro-expressions in that they have a short duration, a low intensity and are only related to local face, so micro-expression features are extracted by a two-stream difference network model without identity information.

Furthermore, the facial expression locating sub-module is specifically configured to:

extract fine-grained change characteristics of local regions of interest in a face by the bilinear convolutional neural network model, and locate durations of different types of expressions in the process of data acquisition; based on the influence of deep local region extraction features on the classification of facial macro-expressions, micro-expressions and calm expressions, select efficient local facial features for fusion with overall features to improve classification accuracy, and label each frame of images in a video sequence with emotional features, so as to locate different types of facial expressions in the video sequence.

Compared with macro-expressions, micro-expressions have a short duration and a low intensity, which makes the difference between images and natural neutral facial expressions not obvious, and the changes between micro-expression facial images and natural facial images are subtle. Therefore, the task of macro-expression and micro-expression location is transformed into fine-grained image classification, and the features of fine-grained image changes are extracted by a bilinear convolutional neural network model to identify micro-expressions and other facial actions. At the same time, considering the features related to local facial regions when facial expressions occur, the overall and local relations of facial expression images are further integrated, and the classification of emotional states is further assisted by extracting fine-grained change features of local regions of interest. By paying attention to the influence of deep local region extraction features on the classification of facial micro-expressions, macro-expressions and calm expressions, efficient local features and overall facial features are selected, the classification accuracy is improved by feature fusion, and the emotional features of each frame of the images in the video sequence are labeled with emotional features, and then different types of facial expressions in the video sequence are located.

Furthermore, the facial emotion state recognition sub-module is specifically configured to: implement hierarchical fusion in an orderly manner according to different types of facial expression features, extract features that can best represent emotional categories from the facial macro-expression features, facial micro-expression features and fusion features according to a support vector machine classifier, and construct an optimal classification model to recognize a current emotional state of the user.

Wherein, the bilinear convolutional neural network model is used to extract the fusion features of the images of the whole and local areas of the face as macro-expression features. In the process of micro-expression feature extraction, the first frame of a facial image collected at the beginning of shopping of the user in a calm state is taken as a reference and input into the self-coding network model to obtain the user's identity feature, and then each subsequent frame of the images is input into the self-coding network model with the same structure to extract the superimposed features of facial micro-expressions and identity information, and then a differential network is used to remove the identity information in the superimposed features and retain the micro-expression features. In order to obtain the optimal emotion classification result, firstly, the macro-expression and micro-expression features of the face are weighted and fused and input into the support vector machine model for the first emotion recognition. Then, the images with inaccurate fusion feature classification are classified by macro-expression and micro-expression features through threshold division. By orderly hierarchical fusion of different types of expression features, the current user's emotional state can be accurately recognized, and is applied to the whole online shopping process to monitor and feedback the user's interest in goods in real time and improve the user's shopping efficiency.

Furthermore, the shopping intention analysis module 103 is specifically configured to:

decide that the user is not interested in shopping content at this time when the emotional state of the user is recognized as a negative state or a negative micro-expression state is hidden with a positive facial expression, the browsing time of the user is short and interaction frequency is high; and

decide that the user is interested in shopping content at this time when the emotional state of the user is identified as a positive state or a positive micro-expression state is hidden by a negative facial expression, the browsing time of the user is long and interaction frequency is low.

Furthermore, the shopping recommendation adjustment module 104 is specifically configured to:

recommend similar products to the user when the emotional state of the user is positive, the interaction frequency with the shopping system is low and the browsing time is long; and adjust the commodity recommendation strategy for the user when the emotional state of the user is negative, the interaction frequency with the shopping system is high and the browsing time is short.

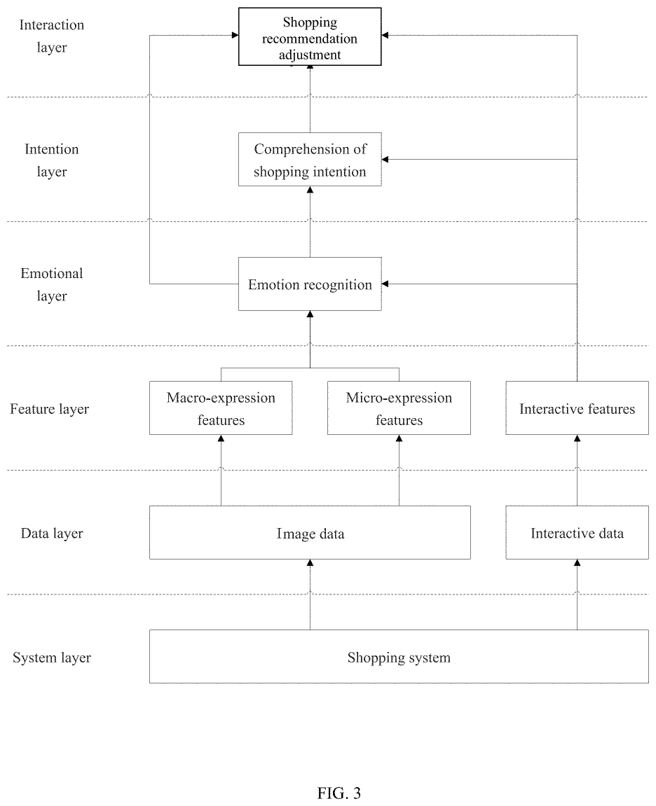

As a specific implementation of the present invention, FIG. 3 is a schematic diagram of a system framework provided by an embodiment of the present invention, which includes a system layer, a data layer, a feature layer, an emotion layer, an intention layer and an interaction layer.

The system layer is a network online shopping system. A user registers and logs in to the system by entering a user name and a password. The User logs in to the account and fills in basic data and inputs them into the user database for storage. After logging in successfully, the user can enter the personal space and see the basic personal information of the user.

The data layer is used for collecting facial image data and interactive behavior data of users during online shopping. The facial image data acquisition module is mainly used for acquiring facial macro-expression features and micro-expression features when users shop online, locating the occurrence time of different types of facial expressions, and further judging the emotional state of the current users; online interactive behavior data collection of input devices adopts an online shopping platform to collect behavior data such as user's browsing time of goods and operation frequency of the interactive devices, which is mainly used to analyze the browsing time and interest degree of goods during online shopping.

The feature layer includes facial macro-expression, micro-expression feature extraction and interactive data feature extraction. The macro-expression feature extraction of facial image data adopts a large number of public expression data sets to train the image self-coding model to extract the macro expression features of the facial image; with regard to the short and imperceptible facial micro-expressions that users involuntarily reveal during shopping, the feature extraction model is also trained by using the public micro-expression data sets. The difference from macro-expressions is that micro-expressions have a short duration, a low intensity and are only locally related to the face. Therefore, the micro-expression features are extracted by removing identity information through the two-stream difference network model. With regards to the feature extraction of interactive data, the median, mean, minimum, maximum, range, standard deviation, variance and other statistical features of the interactive data are extracted.

The emotion layer locates the durations of different types of expressions in the data collection process by extracting fine-grained features of local regions of interest in the face, pays attention to the influence of deep local region extraction features on the classification of calm expressions, micro-expressions and other facial states, selects efficient local features and overall facial features through relevant feature selection algorithms, improves the classification accuracy through feature fusion, marks each frame of images in the video sequence with emotional features, and analyzes the start, peak and end points of micro-expressions to realize location of facial micro-expressions in the video sequence. At the same time, different types of facial expression features are hierarchically fused in an orderly manner. The features that best represent the emotional category are extracted from the macro-facial expression features, micro-facial expression features and fusion features by the support vector machine classifier, and the optimal classification model is constructed to recognize the current user's facial emotional state.

The intention layer judges the degree of interest in the current shopping content through the facial expressions, micro-expressions, browsing time and interaction frequency of the user in the shopping process. When the user's expression is of a negative emotion category or hides his negative micro-expression category with positive facial expressions, the user's browsing time is short and the interaction frequency is high, it means that the user is not interested in shopping content. When the user is in a positive emotional state, the browsing time is longer and the interaction frequency is low, it means that the user is interested in shopping content.

The interactive layer is a shopping recommendation adjustment module, which judges whether the system changes the recommended commodity category and commodity content according to the evaluation result of the online shopping system on the user's interest degree. The shopping recommendation adjustment module mainly depends on the system's judgment on recognition of the facial expressions and comprehension of the shopping intention. When the result of facial expression and micro-expression recognition is a negative emotional state, the system determines that the user is in a state of declining degree of interest at this moment, which is not suitable for recommending this kind of product content to the user, and then adjusts the product category recommendation to the user to improve the shopping efficiency of the user.

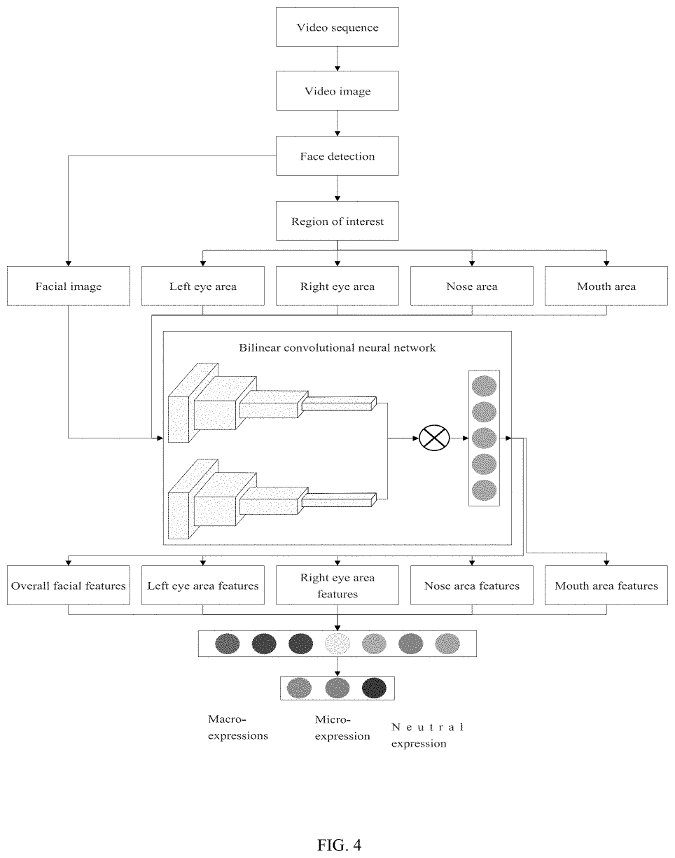

FIG. 4 is a schematic flow chart of facial macro-expression and micro-expression location algorithm according to an embodiment of the present invention. In this part, facial macro-expressions and micro-expressions are located by a bilinear convolutional neural network model. Because of the short duration and low intensity of micro-expressions compared with macro-expressions, the difference between images and natural neutral facial states is not obvious when micro-expressions occur, and there will be subtle changes between micro-expression facial images and natural facial images. Therefore, the task of micro-expression location is transformed into fine-grained image classification, micro-expressions and other facial actions are recognized by extracting the features of fine-grained image changes, and a micro-expression location model based on fine-grained image changes is constructed. At the same time, considering that facial expressions are only related to local facial regions when they occur, this step will further pay attention to the relationship of overall facial images and local facial images, and extracting fine-grained change features of local regions of interest can further assist the classification of emotional states. The present invention pays attention to the influence of deep local region extraction features on the classification of calm expressions, micro-expressions and facial macro-expressions, selects efficient local features and overall facial features through a feature selection algorithm, improves classification accuracy through feature fusion, and marks emotional features for each frame of images in the video sequence.

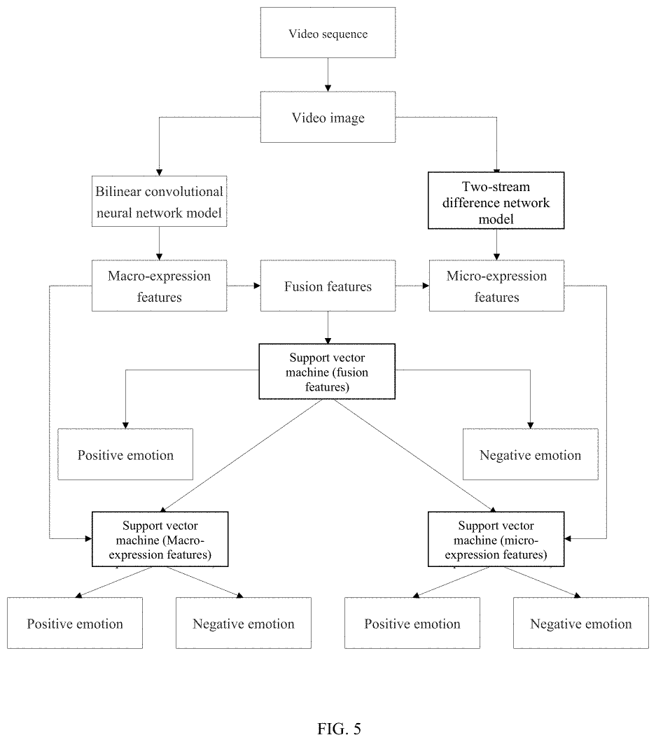

FIG. 5 is a schematic diagram of a facial emotion recognition model based on multi-feature fusion according to an embodiment of the present invention. In view of the complexity of facial expression changes during shopping, the features of facial macro-expression and micro-expression are extracted by a bilinear convolutional neural network model and a two-stream difference network model respectively. Among them, the bilinear convolutional neural network model uses the fusion features of the whole and local areas of facial images as macro-expression features. In the process of micro-expression feature extraction, the first frame of facial images collected at the beginning of shopping of the user in a calm state is taken as a reference and input into the self-coding network model to obtain the user's identity features, and then each subsequent frame of images is input into the self-coding network model with the same structure to extract the superimposed features of facial micro-expressions and identity information, and then the differential network is used to remove the identity information in the superimposed features and retain the micro-expression features. In order to obtain the optimal emotion classification result, the present invention includes the following steps of: firstly, implementing weighted fusion on macro-expression and micro-expression features of a face and inputting the weighted fusion features into a support vector machine model for first emotion recognition; classifying images with inaccurate fusion feature classification through macro-expression and micro-expression features by a threshold division method; and implementing orderly hierarchical fusion on different types of expression features, so as to accurately recognize the current emotional state of the user.

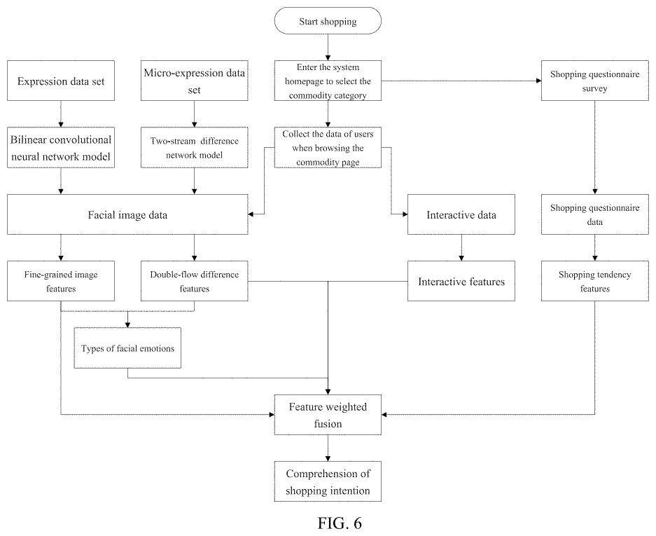

FIG. 6 is a schematic diagram of a shopping intention comprehension model according to an embodiment of the present invention. When users register, their past shopping tendency will be investigated in the form of questionnaires, for example, they are more inclined to shop for daily necessities or study sports goods, and are more accustomed to knowing the practicality or price of goods, etc., so the shopping tendency characteristics are formed according to the questionnaire answers filled by users. After the user enters the system homepage to select the commodity category, the system starts to collect the user's facial image data. Each frame of the image data is input into the bilinear convolutional neural network model and two-stream difference network model which are pre-trained by macro-expression data sets and micro-expression data sets. Fine-grained image features of facial images are obtained as macro-expression features, and two-stream difference features are used as micro-expression features. The optimal facial emotional features are obtained by feature weighted fusion to identify the facial emotional state. At the same time, the interactive time and frequency of the interactive behavior data collected by the system are processed, and the statistical features such as median, mean, minimum, maximum, range, standard deviation and variance of the interactive data are extracted as interactive features. According to the user's shopping tendency characteristics, facial emotion characteristics and interactive behavior characteristics, the user's shopping intention is judged. When the user's facial expression is negative or his negative micro-expressions are hidden with over-positive facial expressions, and the user is not interested in shopping content, then the user's browsing time is short and the interaction frequency is high. When the user's expression is usually more positive or surprised, or the positive micro-expression emotion is hidden by the negative facial expression, then the user is not interested in shopping content at this time, and the browsing time of the user is long and the interaction frequency is low.

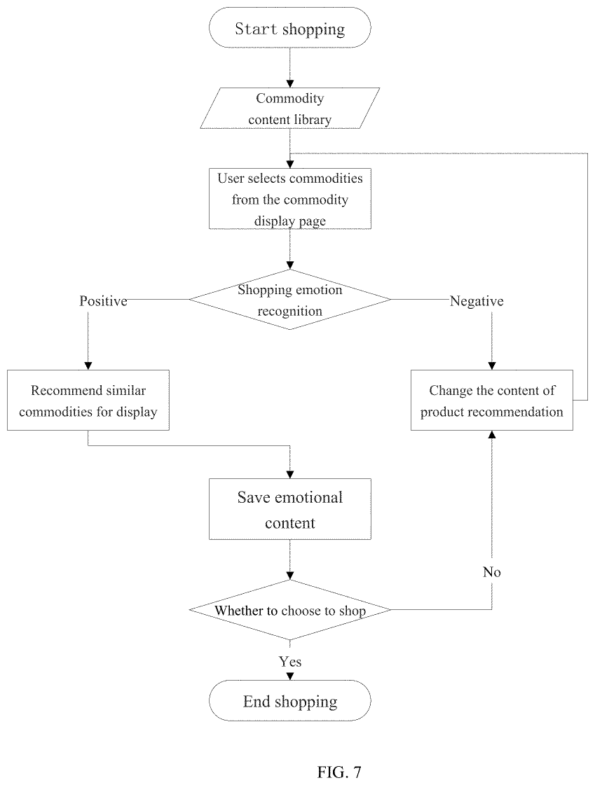

FIG. 7 is a schematic flow chart of shopping recommendation adjustment based on emotional state according to an embodiment of the present invention. The online shopping system needs to implement the function of providing shopping content recommendations to users and analyzing, storing and feeding back their shopping choices in time, so that users can make efficient shopping choices. When the user enters the shopping system homepage to select commodity categories to browse commodities, the system begins to collect the user's facial image data, and identifies the current user's emotional state by analyzing the user's facial macro-expressions and micro-expressions. When the user is in a negative state, the system considers that the commodities recommended to the user cannot attract the user's attention, and at this time the system will change the recommended contents of commodities to the user; when the user is in a positive emotional state, the system considers the products recommended to the user as interesting products, and will continue to recommend similar products to the user for the user to choose, while saving the current emotional content of the user. When the user still does not choose to buy the products he is interested in, the product recommendation is continuously changed until the shopping is completed. After the user finishes learning, the system will automatically save the emotional change trend in the whole online shopping process, which is convenient for the system to inquire about the shopping status of the user at any time period, and to know the learning content that the user is interested in, so as to recommend better shopping choices for the user.

On the basis of facial image data obtained in the online shopping process, the interactive data with dynamic changes and spatiotemporal changes of facial macro-expressions, micro-expressions and calm expressions are processed for the characteristics of image modes in the interactive perception and cognition of users in shopping, so as to realize robust emotional cognition, accurate intention comprehension and process shopping interaction, finally realize the integration of interactive feedback processes and improve the shopping experience of users.

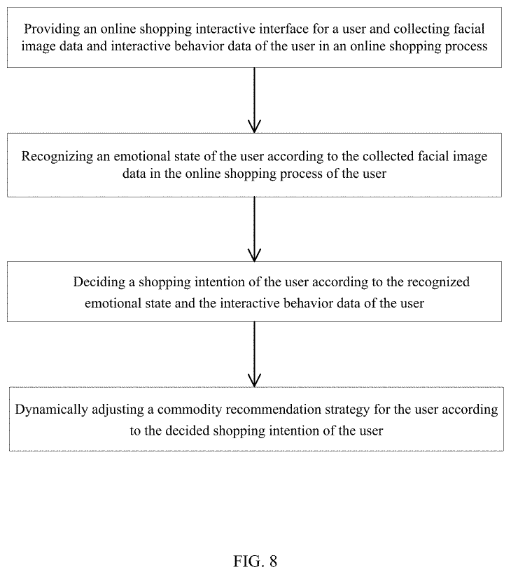

Accordingly, the embodiment of the present invention also provides an online shopping method based on facial emotional state analysis, as shown in FIG. 8, which includes the following steps:

providing an online shopping interactive interface for a user and collecting facial image data and interactive behavior data of the user in an online shopping process;

recognizing an emotional state of the user according to the collected facial image data in the online shopping process of the user;

deciding a shopping intention of the user according to the recognized emotional state and the interactive behavior data of the user; and

dynamically adjusting a commodity recommendation strategy for the user according to the decided shopping intention of the user.

In the method, the specific contents of each step can be referred to the above-mentioned embodiments, and will not be repeated here.

The online shopping method provided by the embodiment of the present invention analyzes the emotional state of the user in the shopping environment by collecting the facial image data of the user in the shopping process, predicts the shopping intention of the user according to the analysis of the emotional state of the user and the interaction behavior between the user and the shopping system, and gives corresponding shopping recommendations, thereby improving the shopping experience of the user.

The above is only a preferred embodiment of the present invention, and is not intended to limit the present invention. Any modifications, equivalent substitutions, improvements, etc. made within the spirit and principles of the present invention shall be included in the scope of protection of the present invention.

What is claimed is:

1. An online shopping system based on a facial emotional state analysis, comprising:
an online shopping module configured to provide an online shopping interactive interface for a user, wherein the online shopping module is configured to collect facial image data and interactive behavior data of the user in an online shopping process;
a facial expression recognition module configured to recognize an emotional state of the user according to the facial image data in the online shopping process of the user;
a shopping intention analysis module configured to decide a shopping intention of the user according to the emotional state and the interactive behavior data of the user; and
a shopping recommendation adjustment module configured to dynamically adjust a commodity recommendation strategy for the user according to the shopping intention of the user.

2. The online shopping system based on facial emotional state analysis according to claim 1, wherein the online shopping module comprises:
a login sub-module configured to allow the user to input a user name and a password to register and log in to the online shopping system, and the login sub-module configured to input account information and basic information of the user into a user database for storage;
a display sub-module comprising a three-level structure, wherein the three-level structure comprises a homepage, a commodity display page and a commodity detail page, wherein the homepage is a commodity category page; the display sub-module is configured for displaying commodity categories on the homepage for users to select the commodity categories to enter the commodity display page, and the display sub-module is configured for the users to select the commodities from different commodities displayed on the commodity display page to enter the commodity detail page for browsing within a predetermined time; and
an acquisition sub-module configured to acquire the facial image data and the interactive behavior data of the user in the online shopping process.

3. The online shopping system according to claim 1, wherein the facial expression recognition module comprises:
a facial macro-expression feature extraction sub-module configured to extract facial macro-expression features according to the facial image data;
a facial micro-expression feature extraction sub-module configured to extract facial micro-expression features according to the facial image data;
a facial expression locating sub-module configured to locate different types of facial expressions according to the facial macro-expression features and the extracted facial micro-expression features;
a facial emotional state recognition sub-module configured to hierarchically fuse features of the different types of the facial expressions in an orderly manner, wherein the facial emotional state recognition sub-module is configured to use a support vector machine to construct a support vector machine classifier for a facial emotional state recognition to classify a current emotional state of the user.

4. The online shopping system according to claim 3, wherein the facial macro-expression feature extraction sub-module is specifically configured to:
adopt a public macro-expression data set for a training to obtain a macro-expression image coding model, wherein the macro-expression image coding model is a bilinear convolutional neural network model;
implement a noise reduction, a segmentation and a normalization pretreatment on the facial image data to obtain pretreated facial image data; and
input the pretreated facial image data into the macro-expression image coding model, and extract the facial macro-expression features of the user.

5. The online shopping system according to claim 3, wherein the facial micro-expression feature extraction sub-module is specifically configured to:
adopt a public micro-expression data set for training to obtain a micro-expression image coding model, wherein the micro-expression image coding model is a two-stream difference network model;
implement a noise reduction, a segmentation and a normalization pretreatment on the facial image data to obtain pretreated facial image data; and
input the pretreated facial image data into the micro-expression image coding model, and extract the facial micro-expression features of the user.

6. The online shopping system according to claim 3, wherein the facial expression locating sub-module is specifically configured to:
extract fine-grained change characteristics of local regions of interest in a face by a bilinear convolutional neural network model, and locate durations of the different types of the facial expressions in a process of data acquisition;
based on an influence of deep local region extraction features on a classification of facial macro-expressions, facial micro-expressions and calm expressions, select efficient local facial features for a fusion with overall features to improve a classification accuracy, and label each frame of images in a video sequence with emotional features to locate the different types of the facial expressions in the video sequence.

7. The online shopping system according to claim 3, wherein the facial emotion state recognition sub-module is specifically configured to:
implement a hierarchical fusion in the orderly manner according to the features of the different types of the facial expression, extract features, wherein the features represent emotional categories from the facial macro-expression features, the facial micro-expression features and fusion features according to the support vector machine classifier, and construct an optimal classification model to recognize the current emotional state of the user.

8. The online shopping system according to claim 1, wherein the shopping intention analysis module is specifically configured to:
decide that the user is not interested in a shopping content at a time when the emotional state of the user is recognized as a negative state or a negative micro-expression state is hidden with a positive facial expression, a browsing time of the user is short and an interaction frequency is high; and
decide that the user is interested in the shopping content at the time when the emotional state of the user is identified as a positive state or a positive micro-expression state is hidden by a negative facial expression, the browsing time of the user is long and the interaction frequency is low.

9. The online shopping system according to claim 1, wherein the shopping recommendation adjustment module is specifically configured to:
recommend similar products to the user when the emotional state of the user is positive, an interaction frequency with the online shopping system is low and a browsing time is long; and
adjust the commodity recommendation strategy for the user when the emotional state of the user is negative, the interaction frequency with the online shopping system is high and the browsing time is short.

10. An online shopping method based on a facial emotional state analysis, comprising the following steps of:
providing an online shopping interactive interface for a user and collecting facial image data and interactive behavior data of the user in an online shopping process;
recognizing an emotional state of the user according to the facial image data in the online shopping process of the user;
deciding a shopping intention of the user according to the emotional state and the interactive behavior data of the user; and
dynamically adjusting a commodity recommendation strategy for the user according to the shopping intention of the user.
